(19) United States
(12) Patent Application Publication
(10) Pub. No.: US 2026/0303337 A1
(43) Pub. Date: Oct. 1, 2026

(54) SECURE CONNECTION OF VIRTUAL MACHINE TO HARDWARE SECURITY MODULE

(71) Applicant: INTERNATIONAL BUSINESS MACHINES CORPORATION, ARMONK, NY (US)

(72) Inventors: Reinhard Theodor Buendgen, Tuebingen (DE); Silvio Dragone, Olten (CH); Volker Urban, Böblingen (DE); Benedikt Wenz, Böblingen (DE); Harald Freudenberger, Fellbach (DE); Andreas Kremser, Böblingen (DE); Timo Schmetzer, Ostfildern (DE)

(21) Appl. No.: 19/092,116

(22) Filed: Mar. 27, 2025

(51) Int. Cl. H04L 9/08

(52) U.S. Cl. CPC H04L 9/0863; H04L 9/0825; H04L 9/0841

(57) ABSTRACT

A trusted execution environment (TEE) may store a connection credential (CC) for accessing a remote hardware security module (HSM). The TEE may negotiate a CC wrapping key (CCWK) with the remote HSM. The TEE may encrypt the CC using the CCWK to generate a wrapped connection credential. The TEE may derive a transport key (TKCC) from the CC. The TEE may provide the wrapped connection credential and a protected version of the transport key to a secure virtual machine (secVM), where the secVM is configured to establish a secure connection with the remote HSM using the wrapped connection credential.

### BACKGROUND

The present disclosure relates to confidential computing and hardware security modules.

A hypervisor, also known as a virtual machine monitor (VMM), is software that enables virtual machines (VMs), each with its own operating system, to run on a physical server. The hypervisor pools and allocates physical computing resources as needed by the VMs. A secure VM (secVM) in confidential computing mode uses a trusted execution environment (TEE) to maintain state, metadata, and secrets on behalf of a secVM. A hardware security module (HSM) is hardware that processes cryptographic operations and does not allow plaintext encryption keys to leave the secure cryptographic environment of the HSM.

### SUMMARY

In some aspects, the techniques described herein relate to a method for securely connecting a secure virtual machine (secVM) to a remote hardware security module (HSM), including: storing, by a trusted execution environment (TEE), a connection credential (CC) for accessing the remote HSM; negotiating, by the TEE, a CC wrapping key (CCWK) with the remote HSM; encrypting, by the TEE, the CC using the CCWK to generate a wrapped connection credential; deriving, by the TEE, a transport key (TKCC) from the CC; and providing, by the TEE, the wrapped connection credential and a protected version of the transport key (pTKCC) to the secVM, wherein the secVM is configured to establish a secure connection with the remote HSM using the wrapped connection credentials.

In some aspects, the techniques described herein relate to a system for securely connecting a secure virtual machine (secVM) to a remote hardware security module (HSM), the system including: a trusted execution environment (TEE) including hardware and firmware configured to: store a connection credential for accessing the remote HSM, negotiate a connection credential wrapping key (CCWK) with the remote HSM, encrypt the connection credential using the CCWK to generate a wrapped connection credential, derive a transport key (TKCC) from the connection credential, and provide a protected version of the transport key (pTKCC) to the secVM; and the secVM configured to: receive the wrapped connection credential and the pTKCC from the TEE, and establish a secure connection with the remote HSM using the wrapped connection credential.

In some aspects, the techniques described herein relate to a computer program product including a computer-readable storage medium storing instructions that, when executed by a processor, cause the processor to perform a method for securely connecting a secure virtual machine (secVM) to a remote hardware security module (HSM), the method including: requesting a wrapped connection credential from a trusted execution environment; receiving, by the secVM, a wrapped connection credential and a protected version of a transport key (pTKCC) from a trusted execution environment (TEE), the wrapped connection credential wrapped created by wrapping a connection credential (CC) stored in the TEE using a connection credential wrapping key negotiated between the TEE and the HSM; and establishing, by the secVM, a secure connection with the remote HSM using the wrapped connection credential, wherein communication over the secure connection is encrypted using a connection credential transport key (TKCC).

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an example computing environment, according to embodiments of the present disclosure.

FIG. 2 depicts a block diagram of an example computing environment, according to embodiments.

FIG. 3 depicts a flowchart of an example method for a secure virtual machine to establish a secure connection to a remote hardware security module, according to embodiments.

FIG. 4 depicts a flowchart of an example method for a trusted execution environment establishing a secure connection between a secure virtual machine and a remote hardware security module, according to embodiments.

FIG. 5 depicts a flowchart of an example method for a hardware security module to establish a secure connection to a remote secure virtual machine, according to embodiments.

FIG. 6 depicts a block diagram of an example computing environment showing an example flow of keys and credentials used in establishing a secure connection between a secure virtual machine and a hardware security module, according to embodiments.

FIG. 7 depicts a flowchart of an example method for a secure virtual machine communicating with a remote hardware security module over a secure connection, according to embodiments

FIG. 8 depicts a flowchart of an example method for trusted hardware/firmware handling encryption and decryption of communication for secure communication between a secure virtual machine and a remote hardware security module is depicted, according to embodiments.

FIG. 9 depicts a flowchart of an example method for a hardware security module responding to requests through a secure connection with a remote secure virtual machine, according to embodiments.

FIG. 10 depicts a sequence diagram of example operations between a secure virtual machine, hardware security module, and trusted execution environment, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to secure virtual machines (secVMs), and more particular aspects relate to establishing a secure connection of a secVM to a remote hardware security module (HSM). While the present disclosure is not necessarily limited to such applications, various aspects of the disclosure may be appreciated through a discussion of various examples using this context.

Allowing a virtual machine (VM) to use a remote HSM to generate and use keys can raise security concerns. If an entity is able to steal the keys and/or other data from the virtual machine, they may be able access the remote HSM and use the stolen keys via a different VM.

Embodiments of the present disclosure provide for securely connecting a secVM utilizing a trusted execution environment (TEE) to a remote HSM such that an outside VM is unable to use keys generated by the HSM via the secure connection. The secVM cannot access secrets maintained by TEE, unless the TEE explicitly returns the secrets to the secVM, and then the secVM can only see the secret in the form it was returned (e.g., as an encrypted secret). The connection credential (CC) and verification keys/certificates used to open a secure connection with the HSM may be stored within the TEE on behalf of the secVM. Secure keys generated by the HSM are bound to the CC and the HSM will only perform cryptographic operations using the secure keys if they are received with a request through the secure connection associated with the CC. This effectively generates a key space that is specific to the CC such that keys generated in a CC-connection can only be used within a CC-connection. Thus, embodiments of the present disclosure provide additional security that prevents an HSM protected key from being stolen and used by a different entity (e.g., a different VM).

Multiple secVMs may be capable of establishing a connection to a single HSM, but each will connect with a different connection credential. Thus, secure keys generated by a first secVM will be incompatible with a second secVM because the secure keys will be bound to the connection credential associated with the connection to the first secVM which will be different from the connection credential associated with the connection to the second secVM.

According to embodiments of the present disclosure, a secVM utilizes a TEE to establish a secure connection with a remote HSM. The secVM requests a wrapped connection credential (WCC) from a TEE for securely connecting to a remote HSM. The TEE stores a connection credential on behalf of the secVM. The prior art describes how the owner of a secVM can securely deploy a secret like a connection credential (CC) in a TEE. E.g., the Crypto Express support for IBM Secure Execution for Linux on IM z16 requires that an association secret is securely deployed in the Ultravisor on behalf of a secure guest. The TEE stores a connection credential (CC) for the secure connection CCID. The TEE may negotiate a wrapping key (CCWK) with the HSM (communicating with the HSM indirectly via the secVM). For example, the TEE may generate a private/public key pair and send the public key (via the secVM) to the HSM such that both the TEE and the HSM can derive CCWK according to a Diffie-Hellman scheme. In an alternative example, the TEE may wrap a CCWK with the HSM public key and send it (via the secVM) to the HSM according to an Rivest-Shamir-Adleman (RSA) or key encapsulation mechanism (KEM) scheme. The TEE wraps the CC using the CCWK to produce the WCC. The TEE derives a transport key (TKCC) from the CC and generates a protected version of the transport key (pTKCC). The TEE returns the WCC and pTKCC to the secVM. The secVM sends a request to open the secure connection CCID with the WCC to the HSM. The HSM unwraps the WCC using the CCWK and stores the CC. The HSM derives TKCC from the CC and opens the secure connection CCID.

According to further embodiments of the present disclosure, the secVM utilizes the TEE to communicate requests to the HSM over the secure connection CCID. The secVM generates a request for the HSM and provides the request to the TEE with the pTKCC. The TEE encrypts the request with the TKCC and returns the encrypted request back to the secVM. The secVM provides the encrypted request to the HSM. The HSM decrypts the request using the TKCC. Note that cryptographic operations on protected versions of key may be implemented by trustworthy firmware outside of the TEE provided that the TEE knows how to create protected versions of keys that are compatible with the trustworthy firmware outside of the TEE. The IBM z cryptographic instructions to operate on CPACF protected keys are an example of such a trustworthy firmware implementation.

If the request is to generate an HSM-protected key, the HSM generates an HSM-protected key that is bound to the CC, encrypts the protected key using the TKCC, and returns the encrypted protected key to the secVM.

If the request is to perform cryptographic operations using a HSM-protected key that is included in the request, the HSM determines whether the HSM-protected key is bound to the CC associated with the secure connection CCID. If the HSM-protected key is not bound to the CC, the HSM returns an error to the secVM. If the HSM-protected key is bound to the CC, the HSM performs the cryptographic operations based on the HSM-protected key and returns a response encrypted by the TKCC to the secVM.

To decrypt the response from the HSM, the secVM provides the encrypted response and the pTKCC to the TEE. The TEE decrypts the response using the TKCC and returns the decrypted response to the secVM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as module 190. In addition to module 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and module 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

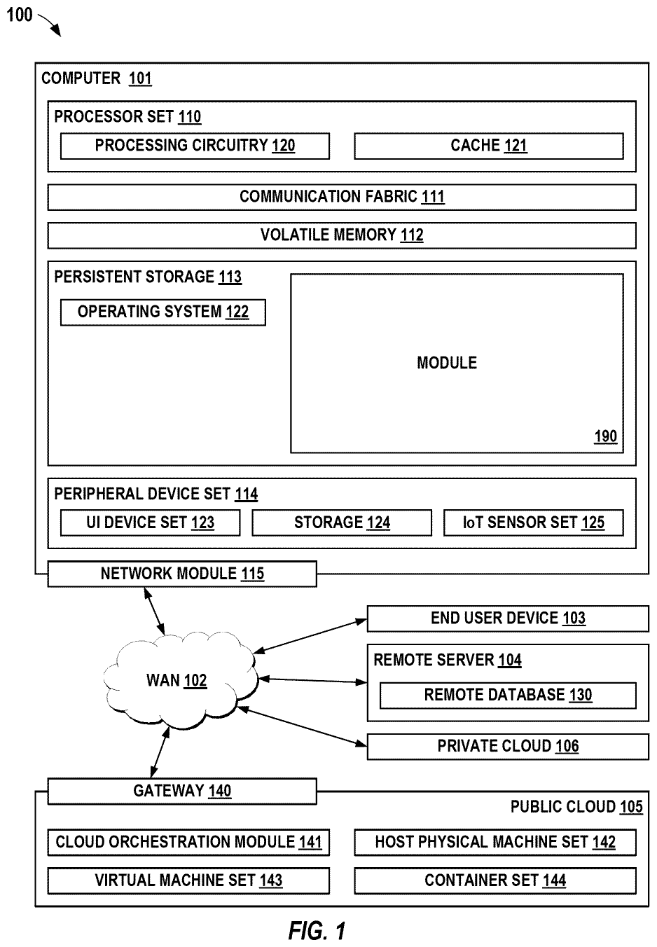

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in module 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

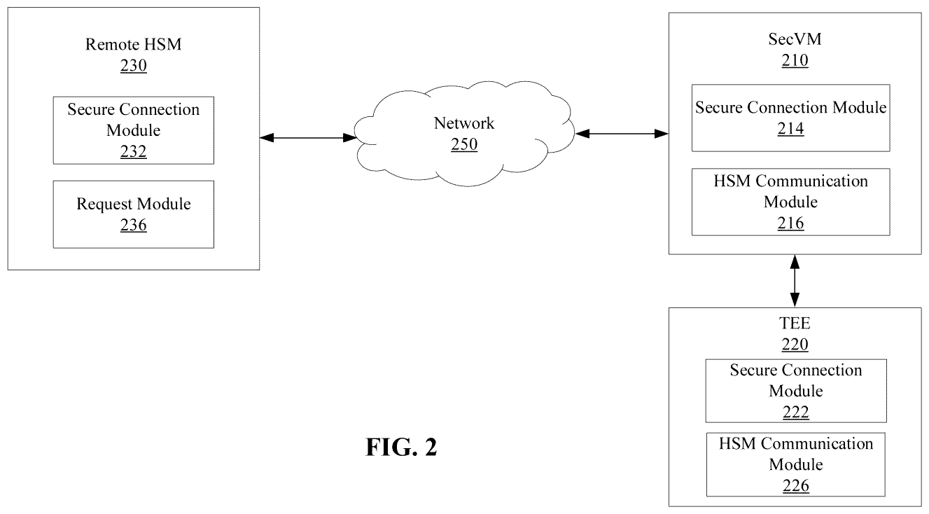

Referring now to FIG. 2, a block diagram of an example computing environment 200 is depicted according to embodiments. Computing environment 200 includes secVM 210, TEE 220, and remote HSM 230. SecVM 210 is a VM running in a confidential computing mode (also known as a secure (execution) guest (SE-guest)). TEE 220 is trusted hardware and firmware used to run a VM in confidential computing mode. TEE 220 may be configured to maintain state, metadata, and secrets on behalf of secVM 210. SecVM 210 may run on a server that contains TEE 220. Remote HSM 230 is an HSM that can be connected to over a network, such as network 250. Remote HSM 230 may be an HSM that does not utilize any user management, such that it will act on requests from any VM that connects to the HSM. The modules depicted in FIG. 2 may be implemented using any suitable combination of software and/or hardware.

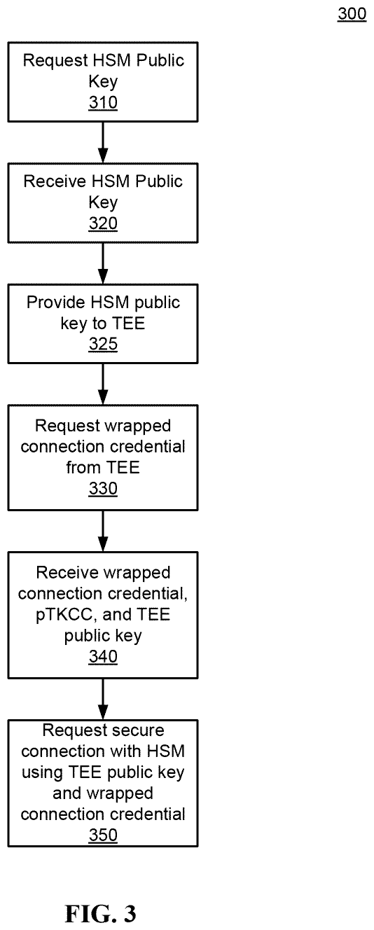

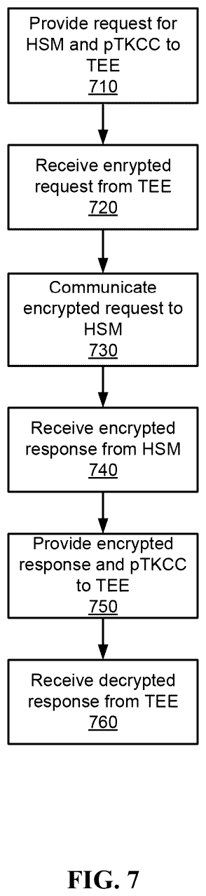

SecVM 210 contains secure connection module 214 configured to establish a secure connection with remote HSM 230 using TEE 220. Secure connection module may be configured to perform some or all of the operations of method 300 described herein and depicted in FIG. 3. SecVM 210 further contain HSM communication module 216 configured to perform communication with remote HSM 230 via the secure connection using TEE 220. HSM communication module 216 may be configured to perform some or all of the operations of method 700 described herein and depicted in FIG. 7.

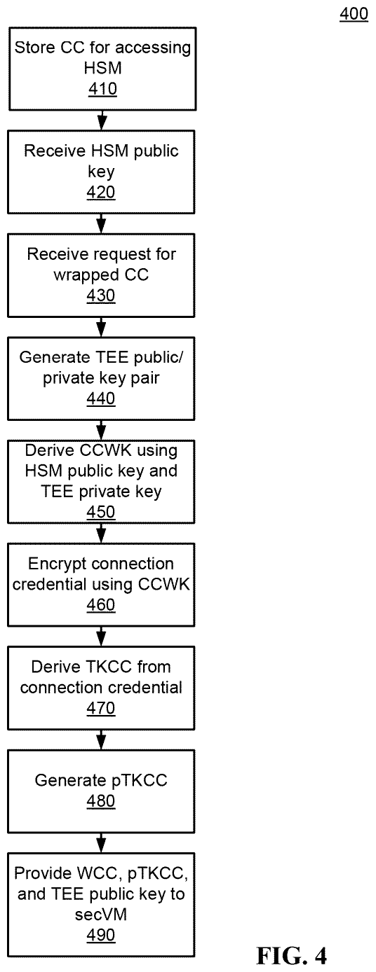

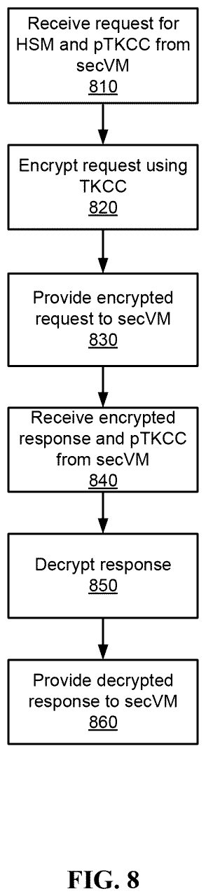

TEE 220 contains secure connection module 222 configured to assist in establishing a secure connection between secVM 210 and remote HSM 230. Secure connection module 222 may be configured to perform some or all of the operations of method 400 described herein and depicted in FIG. 4. TEE 220 further contains HSM communication module 226 configured to assist secVM 210 in communicating with remote HSM 230 via the secure connection. HSM communication module 226 may be configured to perform some or all of the operations of method 800 described in reference to FIG. 8. Although HSM communication module 226 is depicted within TEE 220 in FIG. 2, HSM communication module 226 may be implemented within a different trusted hardware/firmware module than secure connection module 222.

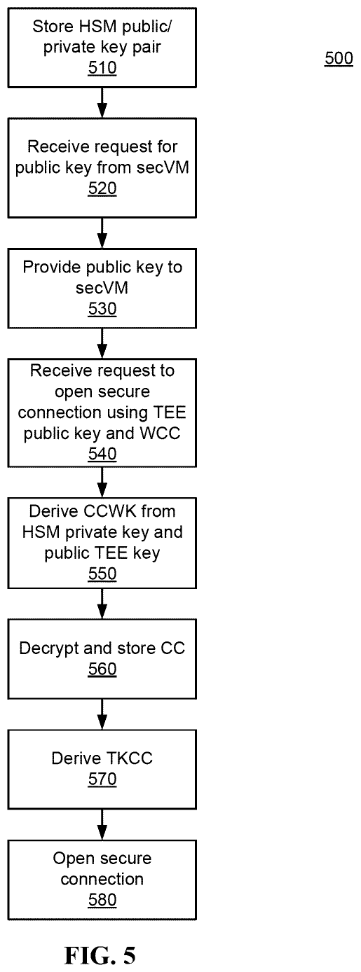

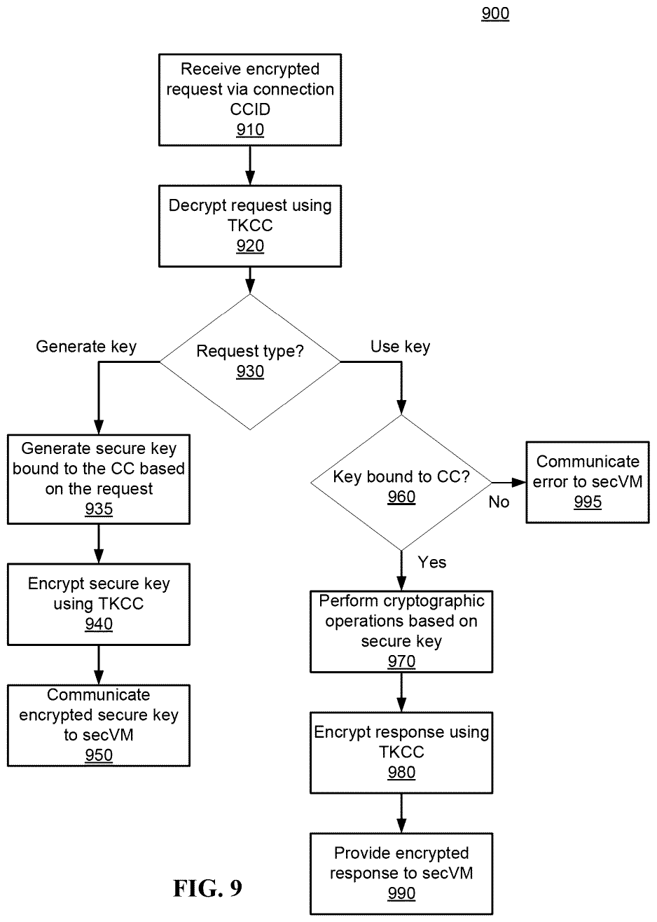

Remote HSM 230 contains secure connection module 232 configured to establish a secure connection with secVM 210. Secure connection module 232 may be configured to perform some or all of the operations of method 500 described herein and depicted in FIG. 5. Remote HSM 230 may further contain request module 236 configured to handle requests from secVM 210 via the secure connection. Request module 236 may be configured to perform some or all of the operations of method 900 described herein and depicted in FIG. 9.

Referring now to FIG. 3, a flowchart of an example method 300 for a secVM to establish a secure connection to a remote HSM is depicted, according to embodiments. At operation 310, the secVM requests an HSM public key from a remote HSM. At operation 320, the secVM receives the HSM public key from the remote HSM. At operation 325, the secVM provides the HSM public key to the TEE. At operation 330, the secVM requests a wrapped connection credential (CC) from a TEE. At operation 340, the secVM receives a wrapped CC, protected transport key (pTKCC), and the TEE public key from the TEE. The wrapped CC is a CC that has been encrypted by the TEE using a connection credential wrapping key (CCWK). The pTKCC is a protected version of the transport key (TKCC) that will be used to encrypt communication between the secVM and remote HSM. At operation 350, the secVM requests a secure connection with the HSM using the TEE public key and the wrapped CC. As described herein, the remote HSM may use the TEE public key to derive the CCWK, decrypt the wrapped CC to obtain and store the CC, and open the secure connection with the secVM.

Referring now to FIG. 4, a flowchart of an example method 400 for a TEE establishing a secure connection between a secVM and remote HSM is depicted, according to embodiments. At operation 410, the TEE stores a connection credential (CC) for accessing the remote HSM. At operation 420, the TEE receives the HSM public key from the secVM. At operation 430, the TEE receives a request for a wrapped CC (WCC) from the secVM. At operation 440, the TEE generates a public/private key pair.

At operation 450, the TEE derives a connection credential wrapping key (CCWK) using the HSM public key and the TEE private key, for example, using a NIST approved key derivation algorithm to derive a key from a common secret computed using Elliptic Curve Diffie-Hellman scheme. At operation 460, the TEE encrypts the CC using the CCWK. At operation 470, the TEE derives the TKCC from the CC. Any suitable derivation algorithm may be used as long as the remote HSM uses the same derivation algorithm. In some embodiments, the TEE and remote HSM may be preconfigured to use a particular derivation algorithm. In some embodiments, the TEE and remote HSM may negotiate a derivation algorithm to use. At operation 480, the TEE generates a protected TKCC (pTKCC). The pTKCC is a key representation that does not disclose the TKCC value, but may be used as input to cryptographic operations performed by the TEE (or other trusted hardware/firmware). At operation 490, the TEE provides the WCC, the pTKCC, and the TEE public key to the secVM. The secVM, as described herein, may use the WCC and TEE public key to open a secure connection with the remote HSM. The pTKCC, as described herein, allows for communication between the secVM and the HSM to be encrypted using the TKCC.

Referring now to FIG. 5, a flowchart of an example method 500 for an HSM to establish a secure connection to a remote secVM, according to embodiments. At operation 510, the HSM stores a public/private key pair. At operation 520, the HSM receives a request for an HSM public key from the secVM. At operation 530, the HSM provides the HSM public key to the secVM. At operation 540, the HSM receives a request from the secVM to open a secure connection using a TEE public key and a wrapped connection credential (WCC). At operation 550, the HSM derives a connection credential wrapping key (CCWK) from the HSM private key and the TEE public key, for example, using a NIST approved key derivation algorithm to derive a key from a common secret computed using Elliptic Curve Diffie-Hellman scheme. At operation 560, the HSM decrypts the WCC using the CCWK and stores the connection credential (CC). At operation 570, the HSM derives the transport key (TKCC) using the CC. At operation 580, the HSM opens the secure connection with the secVM.

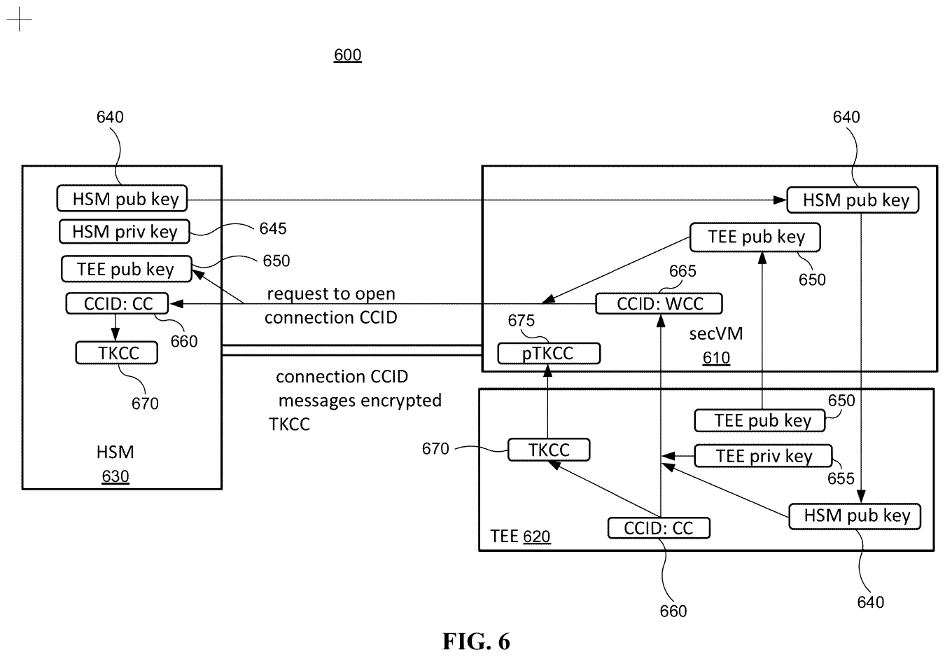

Referring now to FIG. 6, a block diagram of an example computing environment 600 showing an example flow of keys and credentials used in establishing a secure connection between secVM 610 and HSM 630, according to embodiments. In particular, FIG. 6 depicts an example where negotiation of the CCWK utilizes a Diffie-Hellman protocol.

HSM 630 has a public key 640 and a corresponding private key 645. HSM 630 shares its public key 640 with secVM 610 (e.g., in response to a request from secVM 610). SecVM 610 shares the public key with TEE 620 (e.g., with a request for a wrapped connection credential (WCC)). TEE 620 generates a Diffie-Hellman key pair including public key 650 and private key 655. As part of the Diffie-Hellman CCWK negotiation process, the TEE 620 shares its public key 650 with HSM 630 via secVM 610, and uses its private key 655 and the HSM public key 640. TEE 620 generates a connection credential for the secure connection (CCID: CC 660). TEE 620 derives the transport key (TKCC 670) for the secure connection from the CCID: CC. TEE 620 provides a wrapped CC for the secure connection (CCID: WCC 665) that has been wrapped with the negotiated CCWK. TEE 620 also provides a protected version of the TKCC (pTKCC 675) to secVM 610. SecVM 610 provides the CCID: WCC 665 to HSM 630 (e.g., with a request to open secure connection CCID). HSM 630 unwraps the CCID: WCC 665 with the CCWK to obtain CCID: CC 660. HSM 630 derives TKCC 670 from CCID: CC 660. HSM 630 then opens the secure connection CCID with secVM 610, where communication over CCID is encrypted using TKCC 670. As depicted, the plaintext values of CCID: CC 660 and TKCC 670 are not stored in secVM 610 where they may be vulnerable.

Referring now to FIG. 7, a flowchart of an example method 700 for a secVM communicating with a remote HSM over a secure connection is depicted, according to embodiments. At operation 710, the secVM provides a request for the HSM and the pTKCC to the TEE to encrypt the request. The request may include, for example, a request for a secure key or a request to perform cryptographic operations using a secure key. At operation 720, the secVM receives an encrypted request from the TEE that has been encrypted using the TKCC. At operation 730, the secVM communicates the encrypted request to the remote HSM. At operation 740, the secVM receives an encrypted response from the HSM that has been encrypted using the TKCC. At operation 750, the secVM provides the encrypted response and the pTKCC to the TEE for decryption. At operation 760, the secVM receives the decrypted response from the TEE.

Referring now to FIG. 8, a flowchart of an example method 800 for trusted hardware/firmware handling encryption and decryption of communication for secure communication between a secVM and remote HSM is depicted, according to embodiments. Method 800 will be described herein as being performed by the TEE. However, in some embodiments, the operations of method 800 may be performed by a different trusted hardware/firmware than the TEE that establishes the secure connection between the secVM and remote HSM.

At operation 810, the TEE receives a request for the HSM and the pTKCC from the TEE. The request may be, for example, a request to generate a cryptographic key or to perform a cryptographic operation using a cryptographic key. At operation 820, the TEE encrypts the request using the TKCC. In some embodiments, the pTKCC is input into cryptographic operations to derive the TKCC. At operation 830, the encrypted request is provided to the sec VM for communication to the remote HSM. At operation 840, the TEE receives the encrypted response of the HSM from the secVM and the pTKCC. At operation 850, the TEE decrypts the response using the TKCC. In some embodiments, the pTKCC is input into cryptographic operations to derive the TKCC. At operation 860, the decrypted response of the HSM is provided to the secVM.

Referring now to FIG. 9, a flowchart of an example method 900 for an HSM responding to requests through a secure connection with a remote secVM, according to embodiments. At operation 910, the HSM receives an encrypted request via secure connection CCID, where CCID is the name of the connection that was opened with the connection credential (CC). At operation 920, the request is decrypted using the TKCC. At operation 930, it is determined whether the request is a request to generate a cryptographic key or to use a cryptographic key. Although not depicted, other types of requests may be received and handled by the HSM.

If the request from the secVM is to generate a cryptographic key, the HSM may generate a secure key bound to the CC associated with the secure connection based on the request at operation 935. The cryptographic key may be generated using any suitable method. The secure key may be a key handle or a key object. A key handle is a unique identifier or reference used to identify the specific generated cryptographic key stored within the HSM. A key object is the cryptographic key that has been encrypted using an HSM master key stored within the HSM. The secure key may be bound to the CC in different ways according to various embodiments. In some embodiments, the CC may be added in some form as an attribute of the cryptographic key (e.g., a hash value of the CC may be added as an attribute to protect the value of the CC). In some embodiments, the CC may be combined with an HSM master key to create a connection-specific master key that is used to create the protected key. In some embodiments, the HSM may maintain a table of secure keys that have been generated that references the connection credential associated with each secure key. These methods of binding the secure key to the CC are described as examples and are not intended to be limiting. Any suitable method for binding a secure key to the CC may be used. As will be described in reference to operation 960, the HSM may determine whether a secure key that is received in a request from a secVM is bound to the correct connection credential prior to performing cryptographic operations based on the request. At operation 940, the HSM encrypts the secure key using the TKCC. At operation 950, the HSM communicates the encrypted secure key to the secVM.

If, at operation 930, the request is to use a secure key, the HSM determines whether the secure key is bound to the CC associated with the secure connection through which the request was received at operation 960. Determining whether the secure key is bound to the CC varies based on how the CC is bound to the secure key as discussed previously with reference to operation 935. In some embodiments, the HSM may verify that the secure key contains an attribute associated with the CC (e.g., a hash value of the CC). In some embodiments, where the secure key is a key object, the HSM may attempt to decrypt the secure key using a connection-specific master key (e.g., created using a combination of an HSM master key and the CC). In some embodiments, the HSM may refer to a stored table of secure keys to see if the secure key from the request is associated with the CC for the connection CCID. If the HSM determines that the secure key is not bound to the CC, the HSM may communicate an error back to the secVM at operation 995. If the HSM determines that the key is bound to the CC, the HSM performs one or more cryptographic operations based on the secure key at operation 970. At operation 980, the HSM encrypts a response to the request using the TKCC. At operation 990, the HSM provides the encrypted response to the secVM.

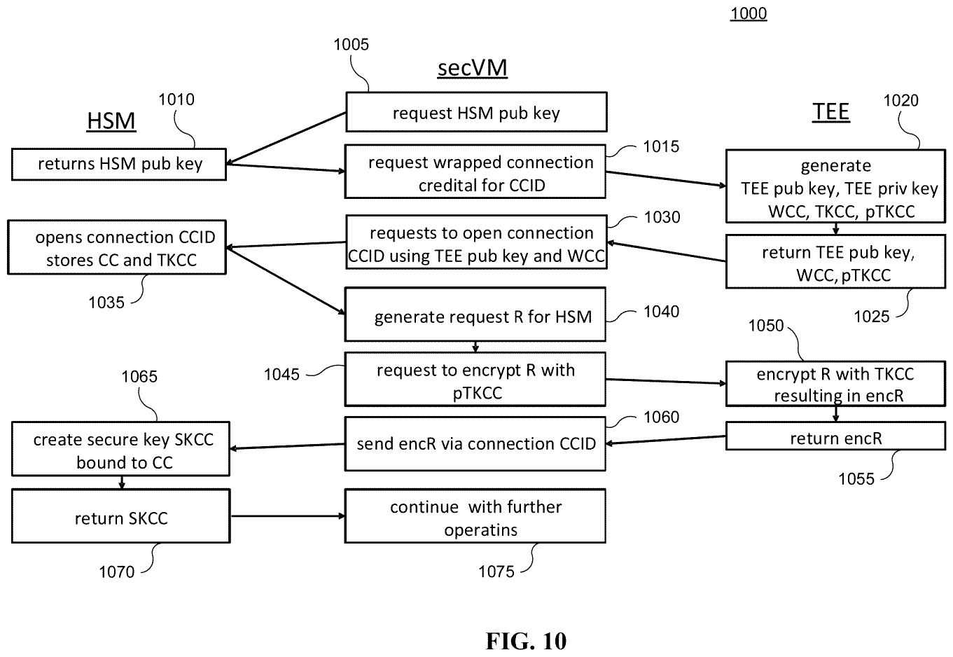

Referring now to FIG. 10, a sequence diagram 1000 of example operations between a secVM, HSM, and TEE are depicted according to embodiments. At operation 1005, the secVM requests an HSM public key from the HSM. At operation 1010, the HSM returns the HSM public key to the secVM. At operation 1015, the secVM requests a wrapped connection credential for a secure connection with the HSM (CCID) from the TEE. The request includes the HSM public key. At operation 1020 the TEE generates a public/private key pair, generates a wrapped connection credential (WCC), derives a transport key (TKCC), and generates a protected transport key (pTKCC). At operation 1025, the TEE returns the TEE public key, WCC, and the pTKCC to the secVM. At operation 1030, the secVM requests to open secure connection CCID using the TEE public key and the WCC. At operation 1035, the HSM opens secure connection CCID, unwraps and stores the CC, and derives and stores the TKCC. At operation 1040, the secVM generates a request to generate a secure key (R) for the HSM. At operation 1045, the secVM provides a request to encrypt R with the pTKCC to the TEE. At operation 1050, the TEE encrypts R with the TKCC, resulting in encR. At operation 1055, the TEE returns the encR to the secVM. At operation 1060, the secVM sends the encR to the HSM via the secure connection CCID. At operation 1065, the HSM decrypts encR and creates a secure key SKCC that is bound to the CC in response to R. At operation 1070, the HSM returns the SKCC to the secVM. At operation 1075, the secVM continues with further operations.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for securely connecting a secure virtual machine (secVM) to a remote hardware security module (HSM), comprising:
storing, by a trusted execution environment (TEE), a connection credential (CC) for accessing the remote HSM;
negotiating, by the TEE, a CC wrapping key (CCWK) with the remote HSM;
encrypting, by the TEE, the CC using the CCWK to generate a wrapped connection credential;
deriving, by the TEE, a transport key (TKCC) from the CC; and
providing, by the TEE, the wrapped connection credential and a protected version of the transport key (pTKCC) to the secVM, wherein the secVM is configured to establish a secure connection with the remote HSM using the wrapped connection credential.

2. The method of claim 1, wherein the remote HSM binds keys generated via the secure connection to the CC.

3. The method of claim 1, further comprising:
receiving, by the TEE, a request for the remote HSM and the pTKCC from the secVM;
encrypting the request, by the TEE, using the TKCC; and
providing, by the TEE, the encrypted request to the secVM for communication to the remote HSM via the secure connection.

4. The method of claim 3, further comprising, in response to the request containing a key bound to a second connection credential, receiving an error from the HSM.

5. The method of claim 3, further comprising:
receiving, by the TEE and from the secVM, an encrypted response from the remote HSM and the pTKCC;
decrypting the encrypted response, by the TEE, using the TKCC; and
providing the decrypted response to the secVM.

6. The method of claim 1, wherein negotiating the CCWK comprises a Diffie-Hellman protocol, wherein a Diffie-Hellman key pair is generated within the TEE and a private key of the Diffie-Hellman key pair remains within the TEE.

7. The method of claim 1, wherein the pTKCC is used as input to cryptographic operations performed by the TEE on behalf of the secVM.

8. The method of claim 1, wherein communication via the secure connection is encrypted using the TKCC.

9. A system for securely connecting a secure virtual machine (secVM) to a remote hardware security module (HSM), the system comprising:
a trusted execution environment (TEE) comprising hardware and firmware configured to:
store a connection credential for accessing the remote HSM,
negotiate a connection credential wrapping key (CCWK) with the remote HSM,
encrypt the connection credential using the CCWK to generate a wrapped connection credential,
derive a transport key (TKCC) from the connection credential, and
provide a protected version of the transport key (pTKCC) to the secVM; and
the secVM configured to:
receive the wrapped connection credential and the pTKCC from the TEE, and
establish a secure connection with the remote HSM using the wrapped connection credential.

10. The system of claim 9, wherein the TEE is further configured to:
receive a request for the remote HSM and the pTKCC;
generate an encrypted request based on the request and the pTKCC, the encrypted request encrypted using the TKCC; and
provide the encrypted request to the secVM for communicating to the remote HSM via the secure connection.

11. The system of claim 9, further comprising the remote HSM, wherein the remote HSM is configured to bind keys generated via the secure connection to the connection credential.

12. The system of claim 11, wherein the remote HSM is further configured to respond with an error to requests to use keys bound to the connection credential if the requests are not received via the secure connection.

13. The system of claim 9, wherein negotiating the CCWK comprises a Diffie-Hellman protocol, wherein the TEE is configured to generate a Diffie-Hellman key pair, and wherein the TEE is configured to keep a private key of the Diffie-Hellman key pair within the TEE.

14. The system of claim 9, wherein the TEE is configured to use the pTKCC as input to cryptographic operations performed on behalf of the secVM.

15. A computer program product comprising a computer-readable storage medium storing instructions that, when executed by a processor, cause the processor to perform a method for securely connecting a secure virtual machine (secVM) to a remote hardware security module (HSM), the method comprising:
requesting a wrapped connection credential from a trusted execution environment;
receiving, by the secVM, a wrapped connection credential and a protected version of a transport key (pTKCC) from a trusted execution environment (TEE), the wrapped connection credential wrapped created by wrapping a connection credential (CC) stored in the TEE using a connection credential wrapping key negotiated between the TEE and the HSM; and
establishing, by the secVM, a secure connection with the remote HSM using the wrapped connection credential, wherein communication over the secure connection is encrypted using a connection credential transport key (TKCC).

16. The computer program product of claim 15, wherein the method further comprises:
generating, by the secVM, a request for the remote HSM;
providing, by the secVM, the request and the pTKCC to the TEE;
receiving, by the secVM, an encrypted request from the TEE, the encrypted request encrypted using the TKCC; and
communicating, by the secVM, the encrypted request to the remote HSM via the secure connection.

17. The computer program product of claim 16, wherein the method further comprises:
receiving a response from the remote HSM, wherein the response includes a secure key bound to a connection credential associated with the wrapped connection credential.

18. The computer program product of claim 16, wherein the method further comprises:
receiving an error from the remote HSM in response to the request containing a key bound to a second connection credential.
